(19) United States
(12) Patent Application Publication
(10) Pub. No.: US 2005/0090299 A1
(43) Pub. Date: Apr. 28, 2005

(54) Mobile phone capable of reducing an electromagnetic specific absorption rate in human bodies

(76) Inventors: Kuo-Wei Tsao, Bade City (TW); Chang-Fa Yang, Sinjhuang City (TW); Shun-Tian Lin, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/965,573

(22) Filed: Oct. 14, 2004

(30) Foreign Application Priority Data
Oct. 22, 2003 (TW) 092129355

(51) Int. Cl. H04M 1/00; H01Q 1/24

(52) U.S. Cl. 455/575.5; 455/550.1

(57) ABSTRACT

A mobile phone capable of reducing an electromagnetic SAR in human bodies includes a base and a cover disposed on the base. The base includes an antenna for transmitting and receiving electromagnetic waves. The cover includes a screen and buttons. Electromagnetic absorbing materials having electric or magnetic loss are applied on the cover to mitigate electromagnetic waves radiating from the antenna into the user. Moreover, a meandered planar inverted-F antenna is attached to the back of the circuit board near the bottom of the base, which can generate a lower near field at the user's side than those in other directions, thereby reducing the electromagnetic specific absorption rate of the mobile phone in human bodies.

This application claims the benefit of Taiwan application Serial No. 92129355, filed Oct. 22, 2003, the subject matter of which is incorporated herein by reference.

### BACKGROUND OF THE INVENTION

1. Field of the Invention

The invention relates in general to a mobile phone capable of reducing an electromagnetic specific absorption rate (SAR) in human bodies, and more particularly to a mobile phone, which can reduce the SAR value in human bodies by applying electromagnetic absorbing materials and a specific antenna design.

2. Description of the Related Art

Rapidly expanding wireless communication technology provides a variety of users with ease and comfort in wireless applications. In wireless communications, mobile phones are used most popularly, and almost everybody in modern countries now owns a mobile phone. Owing to the invention of mobile phones, people can communicate with others by mobile phones everywhere as needed, which reduces the distance of people from each other, and improves the efficiency of information communication. However, according to the studies of mobile phones in these years, it is found that electromagnetic waves radiating from a mobile phone in use might have some negative effects to the user. Generally, mobile phones having external antennas will radiate more electromagnetic waves into the users than those having build-in antennas. Moreover, mobile phones operating in the GSM 900 system will radiate electromagnetic energy twice as more as those in the DCS 1800 system, while electromagnetic radiations from mobile phones in the third-generation (3G) WCDMA system have a strength in between those of the GSM 900 and DCS 1800 systems.

Therefore, many countries have regulations on the SAR value of mobile phones for human bodies. Those SAR regulations are to limit the electromagnetic energy radiating from a mobile phone to be absorbed by a human body for protecting the user from possible electromagnetic effects. For FCC regulations, the maximum SAR value is 1.6 W/kg in average, while the maximum SAR value is 2 W/kg in average for CENELEC regulations. Nowadays, mobile phones are used so popularly and to mitigate the SAR in human bodies due to the mobile phones has become an important issue in designing the mobile phones.

In the prior arts, the following methods are generally provided to reduce the electromagnetic fields in human bodies due to the mobile phone:

(1) Using a mobile phone case to reduce the electromagnetic radiations from the mobile phone. For example, in a mobile phone leather case disclosed in Taiwan Patent No. 456692, metal wires are continuously wound around the case body, and are connected to a lighting component. This lighting component can absorb the electromagnetic waves from the mobile phone to protect the user from electromagnetic illumination. However, the lighting component actually has little effects in absorbing the electromagnetic waves and the near field of the antenna will couple to the metal wires on the leather case and excite secondary radiations. Thus, the electromagnetic energy radiating into the user may even increase. In addition, the leather cases disclosed in Taiwan Patents No. 503086, 399826, and 427603 are made of magnetic absorbing materials covering over the antennas which will affect antenna performance and thus reduce the receiving and transmitting qualities of the mobile phone.

(2) As disclosed in Taiwan Patents 508067, 430241, and 478727, the electromagnetic absorbing apparatus on the mobile phone applies electromagnetic absorbing materials to the phone body or specific parts of the mobile phone to reduce the electromagnetic radiations of the mobile phone for the user. However, no further protecting processes are performed on the antennas in all the inventions. Since near field radiations of the antenna will couple with other elements in the mobile phone in a complicated way, applying only electromagnetic absorbing materials to specific parts will not mitigate the electromagnetic radiations of the mobile phone into the user effectively.

(3) As disclosed in Taiwan Patents 526704, 449257, and 361747, conducting materials are added on the cover of the mobile phone. This approach may protect the mobile phone from exterior electromagnetic waves, but cannot reduce the electromagnetic radiations of the mobile phone into the user. Besides, those metal materials will couple with the antenna to excite secondary radiations, which may even increase the SAR value of the user.

(4) The mobile phone disclosed in Taiwan Patents 408863, 464067, and 507947 have metal plates added near the antennas to reflect electromagnetic waves for reducing electromagnetic radiations into the user. However, since the RF signals of the mobile phone illuminating the metal plates will have significant scattering effects, the metal plates cannot shield electromagnetic waves radiating from the antennas satisfyingly. Also, metal plates adjacent to the antennas will seriously influence antenna performance and reduce the receiving and transmitting qualities of the antenna.

(5) The leather cases covered on mobile phones disclosed in Taiwan Patents 438167 and 441269 can mitigate electromagnetic radiations of the mobile phone for the user. However, those leather cases made of electromagnetic absorbing materials will limit the flexibility of using the mobile phones. Moreover, the electromagnetic constitutive parameters of the absorbing materials are not clearly provided, so that the proper application of the absorbing materials for the leather cases is not known.

(6) The components equipped with hand-free headsets for mobile phones disclosed in Taiwan Patents 438175, 506691, and 496639 are to mitigate electromagnetic waves conducted from the mobile phone to the hand-free headset via the connecting metal wires. However, those components can not prevent the electromagnetic waves from the mobile phone to couple with the connecting metal wires via free space. Thus, there still exist RF coupling currents on the metal wires, which will radiate and give rise to a higher SAR value in the human body near the connecting metal wires compared with those without the wires.

As shown in the above-mentioned examples, those proposed mobile-phone structures cannot effectively reduce the SAR value in human bodies under the condition that the antenna performance can still be maintained. Besides, the mobile phones having the so-called “safety antenna” just use electromagnetic absorbing materials or metal plates to mitigate antenna radiations without re-designing the antenna, which will only have some improvement.

### SUMMARY OF THE INVENTION

The purpose of the invention is therefore to provide a mobile phone capable of reducing the SAR in human bodies. The electromagnetic absorbing materials having electric or magnetic loss and the meandered planar inverted-F antenna (MPIFA) design are provided to effectively reduce the SAR value of the mobile phone for the user. Thus, the user may be protected from possible electromagnetic effects and antenna performance can still be maintained.

The invention achieves the above-identified objects by providing a mobile phone capable of reducing the SAR in human bodies. The mobile phone includes a base and a cover on the base. The base includes an antenna for transmitting and receiving electromagnetic waves, and the cover includes a screen and a number of buttons. Electromagnetic absorbing materials, having electric or magnetic loss, are applied to the cover to mitigate electromagnetic waves radiating from the antenna to the user, where the electric conductivity of the electric absorbing materials is 5 to 20 S/m while the magnetic conductivity of the magnetic absorbing materials is 5000 to 15000 D/m. The cover can be made of the electromagnetic absorbing materials, or be covered with a shell of electromagnetic absorbing materials. The antenna can be a build-in antenna or an external antenna. Besides, an electromagnetic absorbing piece may be disposed at the upper side of the cover to reduce the electromagnetic radiations of the external antenna into the user. The electromagnetic absorbing piece is as high as the external antenna, twice as wide as the antenna, and has a thickness of 0.5 to 2 mm. The electromagnetic absorbing piece can be pulled out or put back to the mobile phone.

The mobile phone further includes a casing covering over the external antenna and an electromagnetic absorbing substance attached to the surface of the casing at the user side. The mobile phone can be a foldable type having an upper cover with one end connected to the upper side of the cover. The electromagnetic absorbing materials are further applied to the upper cover. By applying the electromagnetic absorbing materials to the cover and the antenna of the mobile phone, the electromagnetic radiations of the mobile phone can be effectively shielded from the user.

The invention achieves the above-identified objects by further providing a mobile phone capable of reducing an electromagnetic SAR in human bodies. The mobile phone includes a cover and a base. The cover includes a screen and a number of buttons. The base, situated under the cover, includes a circuit board and an MPIFA, which is attached to the back of the circuit board near the bottom of the body for transmitting and receiving electromagnetic waves. The MPIFA is a planar meandered metal structure including an antenna signal feed point and an impedance-match ground point. The MPIFA generates lower near field in the user side of the mobile phone than in other directions, and thus the SAR value of the mobile phone for the user can be reduced effectively.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a schematic view of the mobile phone having a build-in antenna according to the first preferred embodiment of the invention;

FIG. 1B is a schematic view of the mobile phone having a shell of electromagnetic absorbing materials over its cover according to the first preferred embodiment of the invention;

FIG. 2A is a schematic view of the mobile phone having an external antenna according to the second preferred embodiment of the invention;

FIG. 2B is a schematic view of the mobile phone having a casing covering over the antenna and an electromagnetic absorbing substance attached to the surface of the casing;

FIG. 3A is a schematic view of the foldable-type mobile phone having a build-in antenna according to the third preferred embodiment of the invention;

FIG. 3B is a schematic view of the foldable-type mobile phone having an external antenna according to the third preferred embodiment of the invention;

FIG. 4 is a schematic view of the usage of the mobile phone as the user uses hand-free headsets or wears glasses;

FIG. 5A is a schematic view of the mobile phone according to the fifth preferred embodiment of the invention;

FIG. 5B is a side view of the mobile phone in FIG. 5A;

FIG. 5C is a drawing of the build-in MPIFA in FIG. 5A according to a finite difference time domain (FDTD) program simulation;

FIG. 6 is a return-loss frequency response of the build-in MPIFA in FIG. 5C;

FIG. 7 is a far field radiation pattern in the horizontal plane (θ=90°) for a person using the mobile phone in FIG. 5A;

FIG. 8 is a far field radiation pattern in the φ=0° vertical plane for a person using the mobile phone in FIG. 5A; and

FIG. 9 is a far field radiation pattern in the φ=90° vertical plane for a person using the mobile phone in FIG. 5A.

### DETAILED DESCRIPTION OF THE INVENTION

The main feature of the invention lies on applying the electromagnetic absorbing materials to the case and the antenna of the mobile phone to shield the electromagnetic waves radiated from the antenna, interior circuits, and other metal objects in the mobile phone, and using an MPIFA to generate lower near fields at the user side of the mobile phone so that the SAR of the user can be effectively reduced, and the antenna performance of the mobile phone can still be maintained. In the following, some preferred embodiments of the invention are presented for illustrating how to reduce the SAR value of the mobile phone for the user.

### EXAMPLE ONE

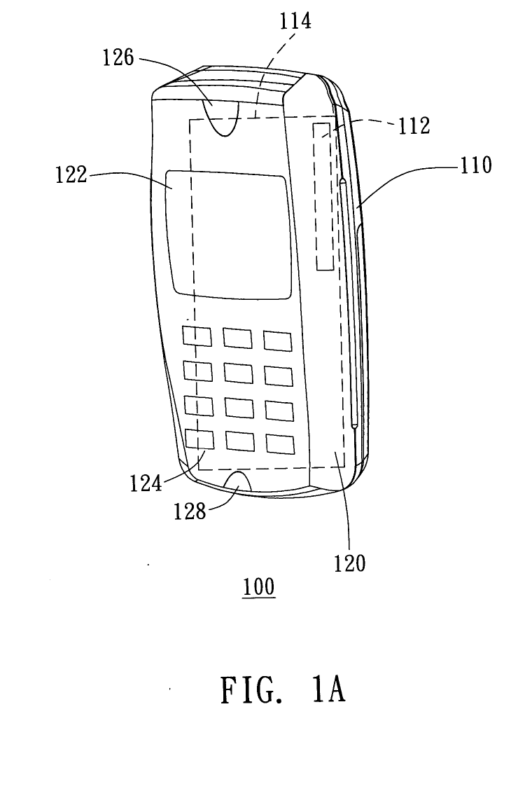

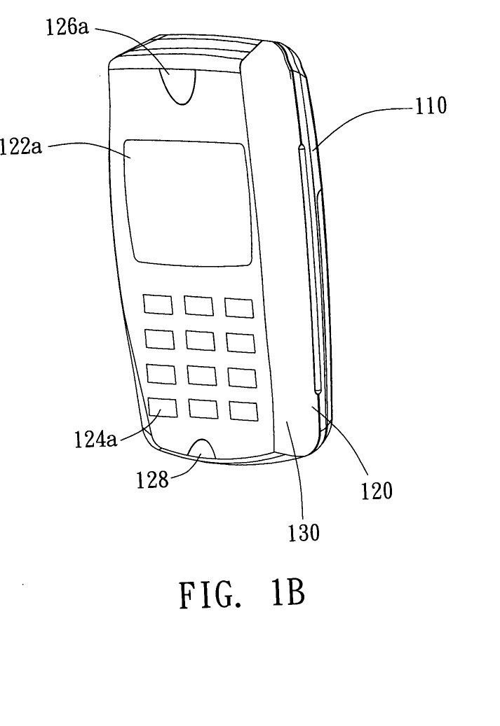

Referring to FIG. 1A, a schematic view of the mobile phone having a build-in antenna according to the first preferred embodiment of the invention is shown. The mobile phone 100 includes a base 110 and a cover 120. The base 110 includes a build-in antenna 112, such as a planar inverted-F antenna, for transmitting and receiving electromagnetic waves, and a circuit board 114 for data processing and transmission. The cover 120 includes a transparent screen 122, buttons 124, an earphone 126 and a microphone 128. The feature of the invention is that the cover 120 close to the user's face as the mobile phone 100 is used, including the buttons 124 and the transparent screen 122, is made of the electromagnetic absorbing materials to mitigate electromagnetic radiations from the antenna 112, the circuit board 114 and metal objects, such as the earphone 126 and the microphone 128. In RF electromagnetic radiation circumstances, the interior circuit board 114, and the metal objects, such as the earphone 126 and the microphone 128, will also couple the RF electromagnetic waves radiated from the antenna 112 to excite secondary radiations. Therefore, gaps of the buttons 124, the earphone 126, and the microphone 128 should also be processed with electromagnetic absorbing materials in order to enhance the electromagnetic shielding effectiveness on the mobile phone.

In addition, a shell 130 composed of electromagnetic absorbing materials can also be added on the cover 120, as shown in FIG. 1B, where the shell 130 includes the screen 122a, the buttons 124a, the earphone 126a, and the microphone 128a corresponding to those on the mobile phone 100, to achieve the purpose of mitigating the SAR of the mobile phone 100 for the user. Or, a paster of electromagnetic absorbing materials can be attached to the cover 120 or a leather case of electromagnetic absorbing materials can be covered over the mobile phone 100, which may also mitigate the SAR of the mobile phone for the user and do not depart from the spirit of the invention.

The above-mentioned electromagnetic absorbing materials are those having electrical or magnetic loss in the RF electromagnetic radiation circumstances, which can be a composite of powder and resin. The powder is formed by powder of metallic soft magnetic materials, such as iron, iron-silicon, iron-nickel, carbonyl iron, and reduced carbonyl iron powders, powders of ceramic soft magnetic materials, such as ferrite magnets Ni_{0.3}Zn_{0.6}Cu_{0.1}Fe₂O₄ and NiCO_{0.05}Mn_{0.1}Fe₂O₄, or powders of dielectric ceramic materials, such as Al₂O₃ and BaTiO₃, or is a mixture of the above-mentioned powders. The resin can be styrenic block copolymer (SBC), epoxy resin, silicone rubber, thermoplastic olefin (TPO), thermoplastic polybutadiene (PB), thermoplastic chlorinated polyethylene (CM), thermoplastic polyvinyl chloride (TPVC), thermoplastic polyester elastomer (TPEE), thermoplastic polyamide (TPA), thermoplastic polyurethane (TPU), or be any composite composed of these materials.

The electromagnetic absorbing materials can also be a monolithic or a composite structure, having a specific shape, formed by high-density metallic soft magnetic materials, such as iron, iron-silicon, iron-nickel, carbonyl iron, and reduced carbonyl iron powders, ceramic soft magnetic materials, such as ferrite magnets Ni_{0.3}Zn_{0.6}Cu_{0.1}Fe₂O and NiCO_{0.05}Mn_{0.1}Fe₂O₄, or dielectric ceramic materials, such as Al₂O₃ and BaTiO₃, in which organic resin can be selectively added. The characteristic parameters of the electromagnetic absorbing materials will differ in different applications. As applied to the mobile phone casing, the preferred electric conductivity of the electromagnetic absorbing materials having electric loss is 5˜20 S/m, and the preferred magnetic conductivity of the electromagnetic absorbing materials having magnetic loss is 5000˜150000 Ω/m. In addition to the electromagnetic materials having only electric or magnetic loss, those having both electric and magnetic loss can also be used in order to enhance the electromagnetic absorbing effectiveness.

By taking the dual-band build-in planar inverted-F antenna as an example, simulated results show that in the 900 MHz band, the largest SAR value of the mobile phone 100 for the human head can be reduced by 32%, the average SAR value can be reduced by 25%, and the antenna performance can even be improved by 1%. As for the 1800 MHz band, the largest SAR value can be reduced by 35%, the average SAR value can be reduced by 17%, and the antenna performance is reduced by only 4%.

### EXAMPLE TWO

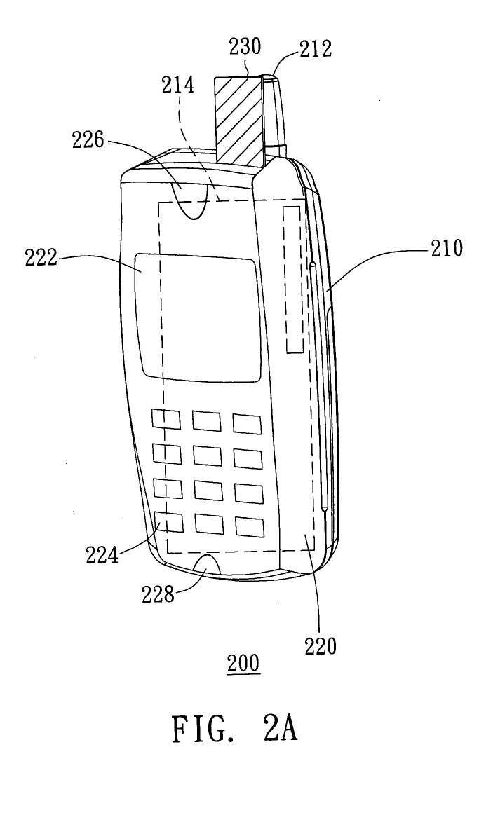

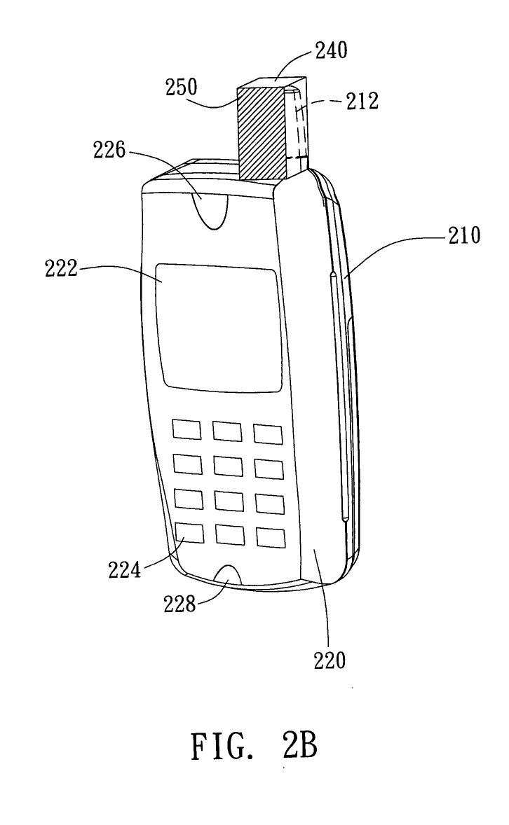

Referring to FIG. 2A, a schematic view of the mobile phone having an external antenna according to the second preferred embodiment of the invention is shown. The mobile phone 200 includes a base 210 and a cover 220. The base 210 includes an external antenna 212, such as a monopole antenna or a spiral antenna, and a circuit board 214. The cover 220 includes a transparent screen 222, buttons 224, an earphone 226, and a microphone 228. Similar to the method of reducing the SAR of the mobile phone 100 described in the first example, the cover 220 close to the user's face as the mobile phone 200 is used, including the buttons 224, the transparent screen 222, the earphone 226, and the microphone 228, is made of the electromagnetic absorbing materials. Also, the gaps of the buttons 224, the earphone 226, and the microphone 228 are processed with the electromagnetic absorbing materials. What differs from the first example is that the external antenna 212, a main radiating source of the mobile phone 200, is further shielded. As shown in FIG. 2A, an electromagnetic absorbing piece 230 is disposed at the upper side of the cover 220, parallel to the antenna 212, and departed 1 to 2 cm from the antenna 212 in the direction to the user's face. The electromagnetic absorbing piece 230 is as high as the antenna 212, and is twice as wide as the antenna 212. The preferred thickness of the electromagnetic absorbing piece 230 is 0.5 to 2 mm. Such design can reduce the SAR value of the mobile phone 200 and the antenna performance can still be maintained. The dimensions of the electromagnetic absorbing piece 230 are not limited to those described above, and can be adjusted according to different antenna near-field patterns of the mobile phone 200.

Moreover, the above-mentioned electromagnetic absorbing piece 230 can also be disposed in the mobile phone 200 or has one end connected to the upper side of the mobile phone 200. When the mobile phone 200 is used and attached to the user's face, the electromagnetic absorbing piece 230 is pulled out or lifted up, and when the mobile phone 200 is hand-free or a hand-free headset is used, the electromagnetic absorbing piece 230 is pushed back or put down to prevent influencing the antenna performance. Therefore, the SAR value of the mobile phone 200 for the user can be reduced and the communication quality of the mobile phone 200 can still be maintained.

As shown in FIG. 2B, a casing 240 without electric or magnetic loss, such as made of plastic, can also be used to cover over the antenna 212, and an electromagnetic absorbing substance 250 is attached to the surface of the casing 240 at the user side. Thus, the electromagnetic absorbing substance 250 is apart from the antenna 212 to prevent influencing the antenna performance.

By taking a dual-band spiral antenna as an example, as the electromagnetic absorbing material is applied to the cover 220 and the electromagnetic absorbing piece 230 is disposed at the upper side of the cover 220, simulated results show that in the 900 MHz band, the largest SAR value of the mobile phone 200 for the human head can be reduced by 60%, the average SAR value can be reduced by 53%, and the antenna performance can even be improved by 11%. As for the 1800 MHz band, the largest SAR value can be reduced by 63%, the average SAR value can be reduced by 45%, and the antenna performance is reduced by only 6%.

### EXAMPLE THREE

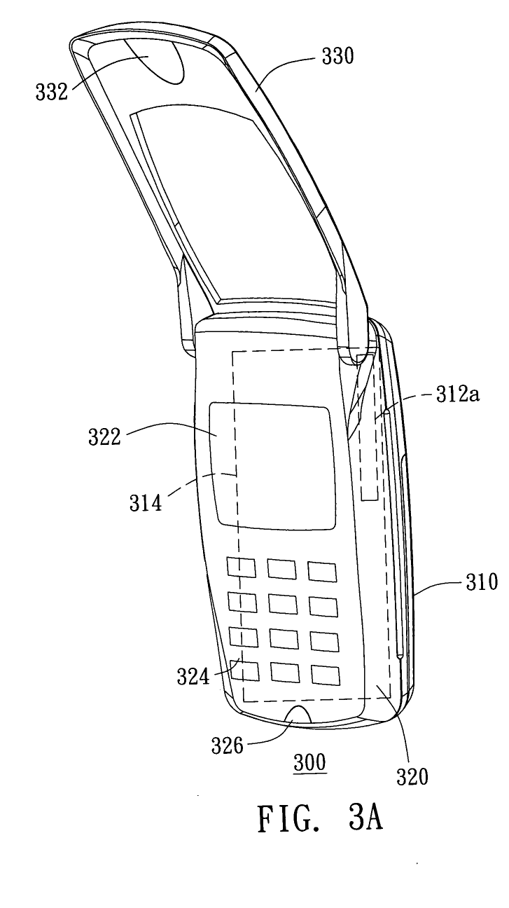

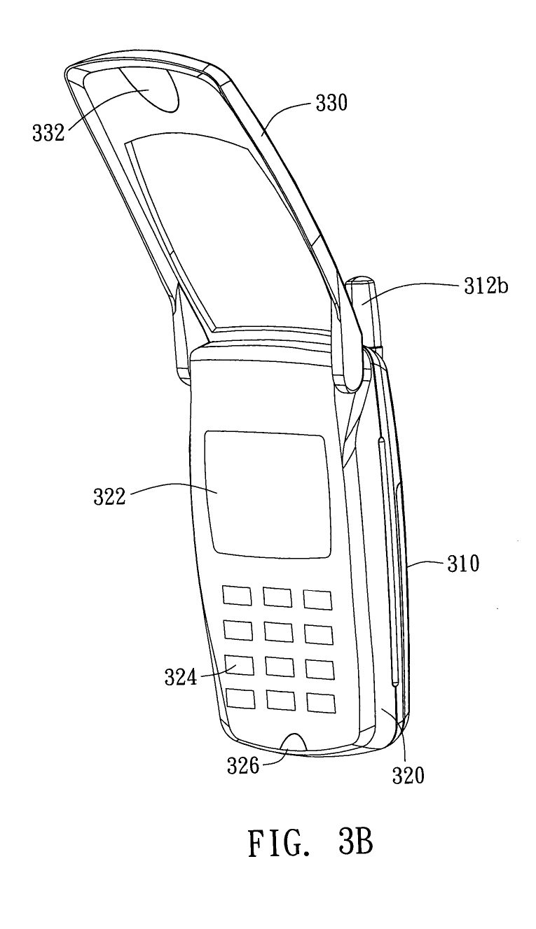

Referring to FIGS. 3A and 3B, schematic views of the foldable-type mobile phones according to the third preferred embodiment of the invention are shown. The foldable-type mobile phone 300 includes a base 310, a cover 320, and an upper cover 330. The base 310 includes an antenna 312, and a circuit board 314, and the cover 320 includes a transparent screen 322, buttons 324, and microphone 326. Moreover, the upper cover 330 includes an earphone 332 disposed at the upper side of the lifted up upper cover 330. The antenna 312 can be the build-in antenna 312a in FIG. 3A or the external antenna 312b in FIG. 3B. Similar to the mobile phones 100, and 200 in the first and the second examples, the electromagnetic absorbing materials can be applied to the upper cover 330 and the cover 320 of the foldable-type mobile phone 300 so as to reduce the SAR value of the antenna 312.

The upper cover 330 of the above-mentioned foldable-type mobile phone 300 can be made of electromagnetic absorbing materials directly, or be attached by a paster of electromagnetic absorbing materials, or be covered by a leather case of electromagnetic absorbing materials, or a shell of electromagnetic absorbing materials, which can also mitigate the electromagnetic radiations of the antenna 312 into the user.

The skill of applying electromagnetic absorbing materials to the cover of the mobile phone in the invention is not limited to the mobile phones described above. In fact, any type of mobile phones can apply this skill to reduce the SAR in human bodies, and thus will not depart from the spirit of the invention.

### EXAMPLE FOUR

In addition to the applications in the first, the second, and the third examples, the electromagnetic absorbing materials can also be applied to the mobile phone accessories, such as hand-free headsets and associated metal wires, and metal parts of wearing objects, such as spectacles and necklaces, in order to mitigate the SAR of the mobile phone for the user.

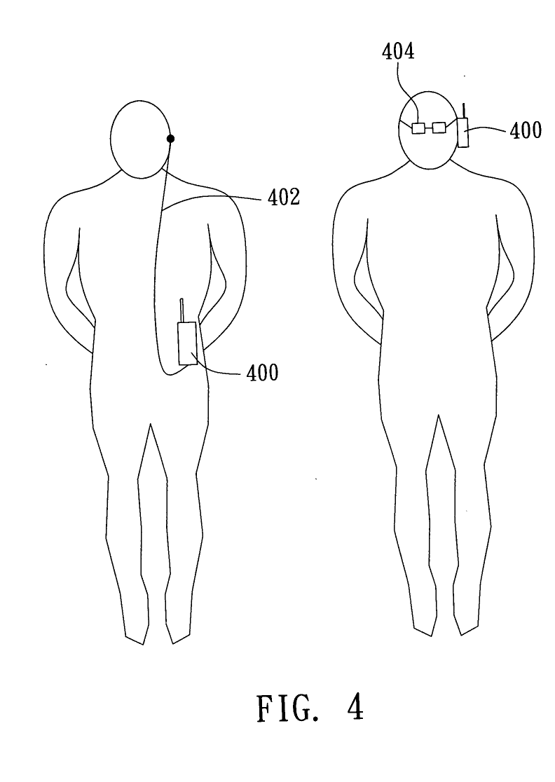

Referring to FIG. 4, a schematic view of the usage of the mobile phone as the user uses a hand-free headset or wears glasses is shown. Since RF electromagnetic waves radiated from the mobile phone 400 will couple the hand-free headset metal wires 402 via free space to excite secondary radiations, the electromagnetic absorbing materials can be applied to the metal wires 402 so as to prevent the electromagnetic waves of the mobile phone 400 from coupling the metal wires 402, and reduce radiations generated by the current flowing on the metal wires 402 due to the mobile phone 400, thereby reducing the SAR value of the mobile phone 400 for the user. Simulated results show that the largest SAR in the human bodies generated from the secondary radiations of the metal wires 402 can be reduced by 37%, and the average value can be reduces by 55%.

Furthermore, as shown in FIG. 4, the metal parts of spectacles, such as the eyeglass frame 404, will also be coupled by the electromagnetic waves radiating from the mobile phone 400 to excite secondary radiations, and thus might damage adjacent sensitive organs of the user, such as eyeballs and head. Therefore, the above-mentioned electromagnetic absorbing materials can also be applied to the eyeglass frame 404 to prevent these sensitive organs from the effects of the secondary radiations. The preferred electric conductivity of the electromagnetic absorbing materials applied to the hand-free headset metal wires 402 or the eyeglass frame 404 is about 0.1 to 5 S/m.

### EXAMPLE FIVE

Except that the electromagnetic absorbing materials is applied to the cover and the antenna of the mobile phone, hand-free headset metal wires, and metal parts of wearing objects to reduce the electromagnetic radiations into human bodies, the fundamental approach for reducing the SAR value of the mobile phone for human bodies lies on its antenna design. The fifth example will disclose a specific antenna design for improving antenna radiation patterns to reduce the SAR value of the mobile phone for human bodies.

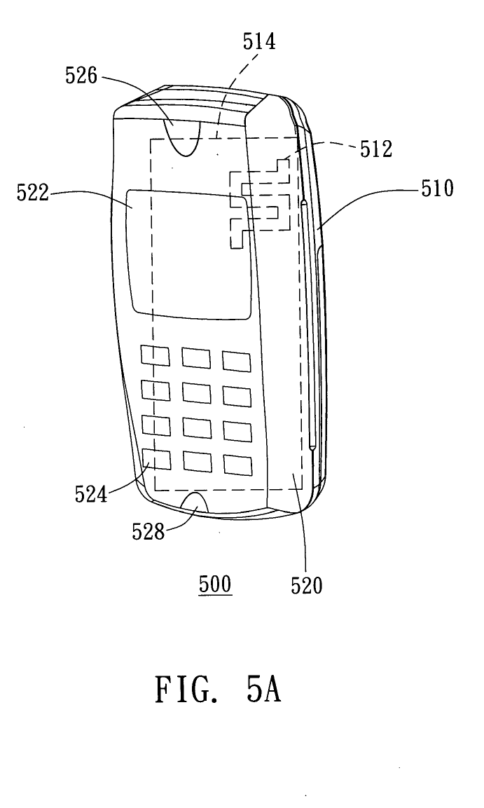

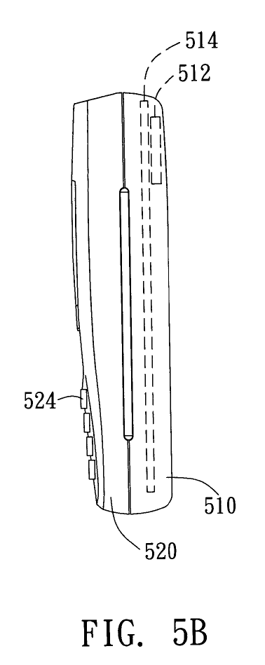

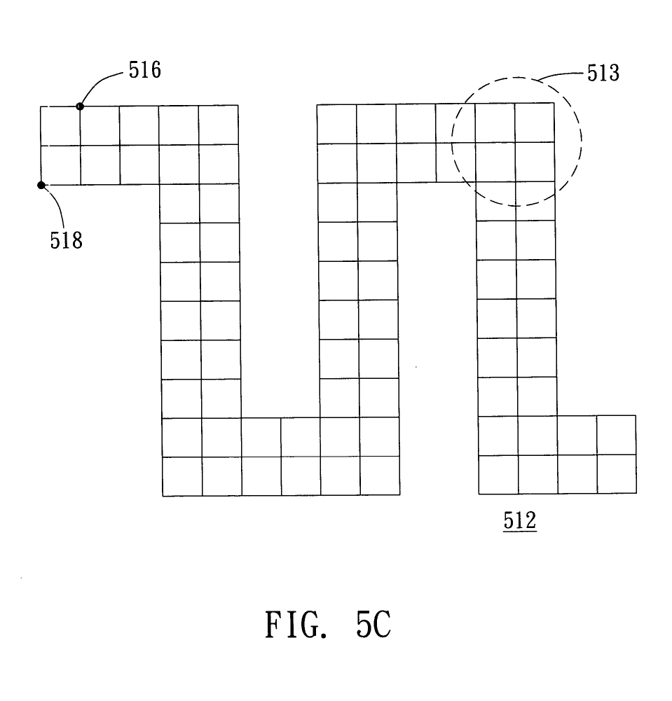

Referring to FIG. 5A, a schematic view of the mobile phone according to the fifth preferred embodiment of the invention is shown. The mobile phone 500 includes a base 510 and a cover 520. The base 510 includes an MPIFA 512 and a circuit board 514. The antenna 512 is disposed over the back of the circuit board 514 as shown in FIG. 5B. The cover 520 includes a transparent screen 522, buttons 524, an earphone 526, and a microphone 528.

Referring to FIG. 5C, a drawing of the build-in MPIFA 512 in FIG. 5A according to a FDTD program simulation is shown. The mesh sizes are δ=Δx=Δy=Δz=1.25 mm. Similar to the structure of the planar inverted-F antenna (PIFA), the MPIFA 512 can be attached to the back of the circuit board 514. However, the metal surface of the MPIFA 512 has a number of meandered parts 513, as shown in FIG. 5C. The antenna 512 is shaped to have six perpendicularly meandered parts 513, and thus the volume of the antenna 512 can be reduced to better fit into the back of the mobile phone 500. Moreover, the antenna 512 includes an antenna signal feed point 516 and an impedance-match ground point 518. The antenna 512 has an area of 18.75 mm×12.5 mm, and is distant from the ground surface of the circuit board 514 by 8.75 mm. The reflecting effect of the ground surface of the circuit board 514 mitigates the electromagnetic radiations of the antenna 512 in the user's direction and thus reduces the SAR of the mobile phone 500.

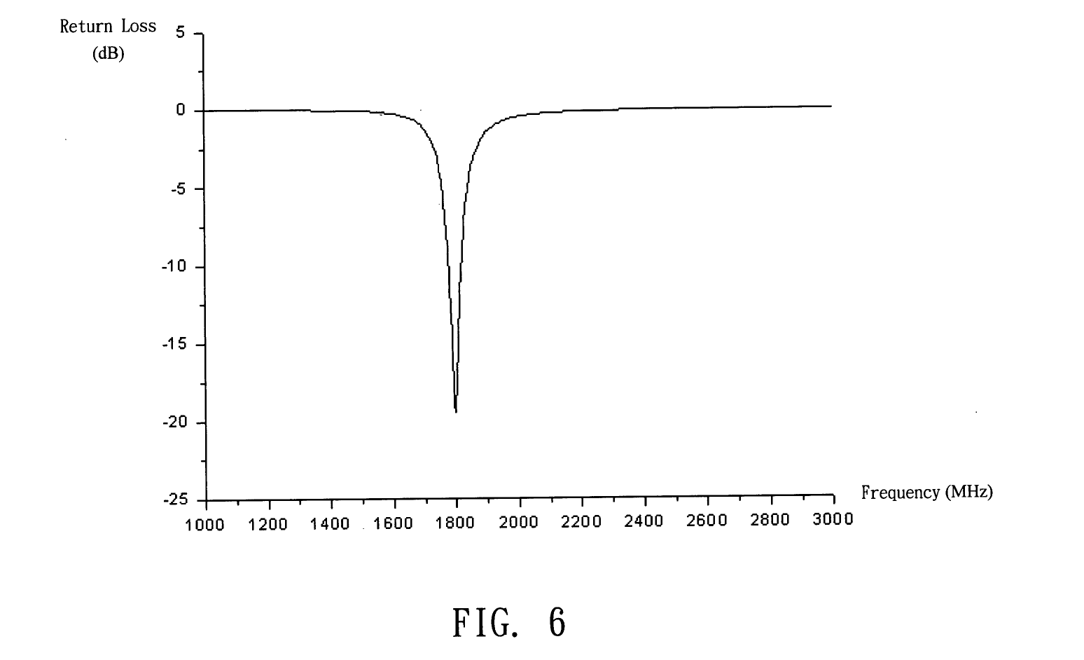

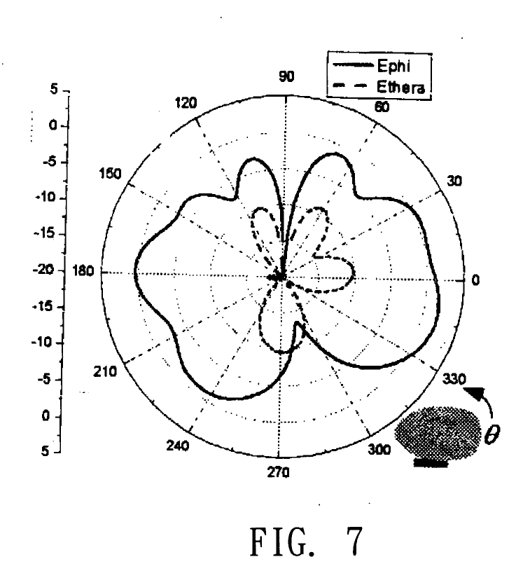

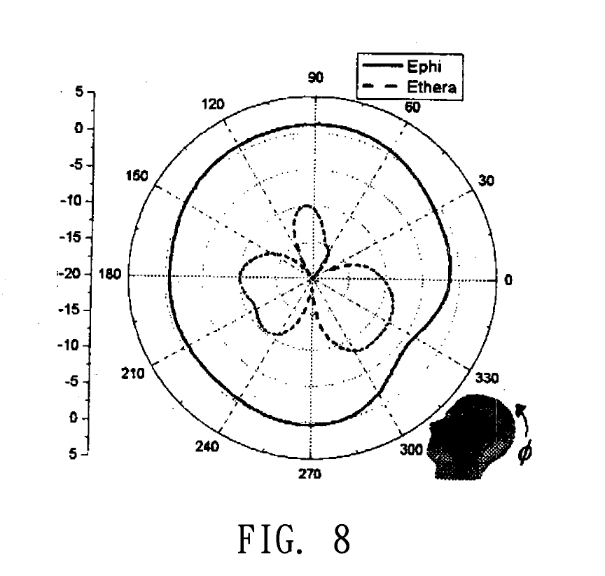

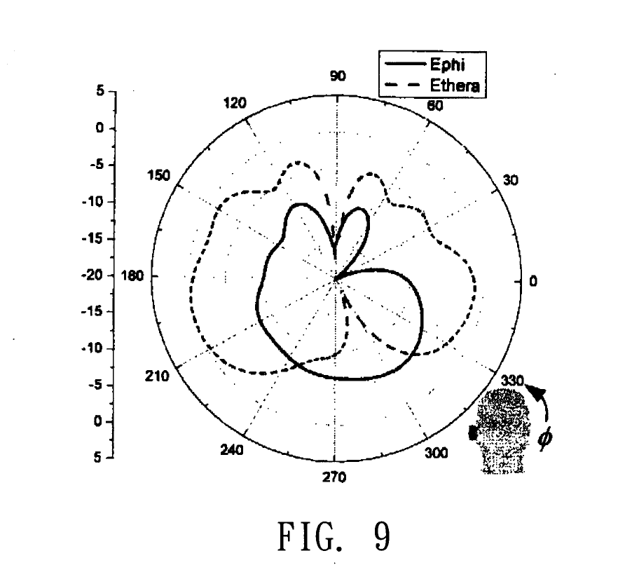

The FDTD simulations in FIG. 6 show that low return loss of the MPIFA 512 occurs at frequencies around 1800 MHz. FIGS. 7, 8, and 9 respectively plot far field radiation patterns in the horizontal plane (θ=90°), the θ=0° vertical plane, and the θ=90° vertical plane for a person using the mobile phone 500. The signals fed in the antenna 512 are at a frequency of 1800 MHz. These far field radiation patterns indicate that antenna field radiating in the direction of the user's head is obviously lower than those in other directions. In comparisons with the external antenna (the dual-band spiral type), the largest SAR value of the MPIFA 512 in the invention is reduced by 70%, and the average SAR value is reduced by 47%. If the electromagnetic absorbing materials are also applied to the cover and the antenna of the mobile phone, the largest SAR value and the average SAR value can then be reduced by 80% and 56%, respectively. Therefore, the build-in MPIFA 512 design can mitigate the SAR value of the mobile phone 500 in human bodies effectively.

The feature of the invention lies on the electromagnetic absorbing materials having electric or magnetic loss to be applied on the surface of the cover and the antenna of the mobile phone at the user side to reduce the electromagnetic radiations of the mobile phone in human bodies. Also, the electromagnetic absorbing materials can be applied to metal accessories, such as hand-free headset wires and metal parts of wearing objects, such as eyeglass frames, necklaces, and earrings to mitigate the secondary radiations generated from metal materials coupled by the electromagnetic waves from the antenna. Thus, the electromagnetic radiations of the mobile phone into the user may be reduced.

Besides, the skill of using the build-in MPIFA to generate lower near field in the user side of the mobile phone than those in other directions can be applied to 2G, 3G, and any other mobile phones in the future to reduce the SAR value of the mobile phone in human bodies. As the combination of the applications of electromagnetic absorbing materials and the antenna design are employed, the SAR value of the mobile phone can be reduced more than 80%, and the antenna performance can still be maintained, as compared with the dual-band spiral antenna in the market.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A mobile phone capable of reducing an electromagnetic specific absorption rate (SAR) in human bodies, the mobile phone comprising:
a base, comprising an antenna for transmitting and receiving electromagnetic waves; and
a cover, disposed on the base, the cover comprising a screen and a plurality of buttons, wherein an electromagnetic absorbing material having electric or magnetic loss is applied to the cover to mitigate electromagnetic waves radiated from the antenna;
wherein the electric conductivity of the electromagnetic absorbing materials having electric loss is 5 to 20 S/m and the magnetic conductivity of the electromagnetic absorbing materials having magnetic loss is 5000 to 150000 Ω/m.

2. The mobile phone according to claim 1, wherein the cover is made of the electromagnetic absorbing material.

3. The mobile phone according to claim 1, wherein the cover is covered over by a shell made of the electromagnetic absorbing material.

4. The mobile phone according to claim 1, wherein the cover is attached by a paster made of the electromagnetic absorbing material.

5. The mobile phone according to claim 1, wherein the mobile phone is covered over by a leather case made of the electromagnetic absorbing material.

6. The mobile phone according to claim 1, wherein the antenna is an external antenna and an electromagnetic absorbing piece is disposed at the upper side of the cover to mitigate electromagnetic waves radiating from the external antenna into a user.

7. The mobile phone according to claim 6, wherein the electromagnetic absorbing piece is as high as the external antenna, twice as wide as the external antenna, and has a thickness of 0.5 to 2 mm.

8. The mobile phone according to claim 7, wherein the electromagnetic absorbing piece can be pulled out or pushed back under the cover.

9. The mobile phone according to claim 7, wherein the electromagnetic absorbing piece can be lifted up or put down at the upper side of the cover.

10. The mobile phone according to claim 1, wherein the antenna is an external antenna and the mobile phone comprises a casing covering over the external antenna, and an electromagnetic absorbing substance is attached to the surface of the casing in the direction of the user.

11. The mobile phone according to claim 10, wherein the casing is made of plastic.

12. The mobile phone according to claim 1, wherein the mobile phone is a foldable-type mobile phone having an upper cover and the upper cover is made of the electromagnetic absorbing material.

13. The mobile phone according to claim 1, wherein the mobile phone is a foldable-type mobile phone having an upper cover and the upper cover is covered over by a shell made of the electromagnetic absorbing material.

14. The mobile phone according to claim 1, wherein the mobile phone is a foldable-type mobile phone having an upper cover and the upper cover is attached by a paster made of the electromagnetic absorbing material or covered over by a leather case made of the electromagnetic absorbing material.

15. The mobile phone according to claim 1, wherein the mobile phone comprises an earphone and a microphone, and gaps of the buttons, the earphone, and the microphone are processed with the electromagnetic absorbing material.

16. The mobile phone according to claim 1, wherein the mobile phone comprises a hand-free headset and the electromagnetic absorbing material is applied to the headset metal wires.

17. The mobile phone according to claim 16, wherein the electric conductivity of the electromagnetic absorbing material applied to the hand-free headset metal wires is 0.1 to 5 S/m.

18. The mobile phone according to claim 1, wherein the electromagnetic absorbing material is a composite of powder and resin.

19. The mobile phone according to claim 18, wherein the electromagnetic absorbing material is any composition of a metallic soft magnetic material, a ceramic soft magnetic material, and a dielectric ceramic material.

20. The mobile phone according to claim 19, wherein the resin is any composition of a styrenic block copolymer (SBC), epoxy resin, silicone rubber, thermoplastic olefin (TPO), thermoplastic polybutadiene (PB), thermoplastic chlorinated polyethylene (CM), thermoplastic polyvinyl chloride (TPVC), thermoplastic polyester elastomer (TPEE), thermoplastic polyamide (TPA), and thermoplastic polyurethane (TPU).

21. The mobile phone according to claim 1, wherein the electromagnetic absorbing material is a composite of a high-density metallic soft magnetic material, a ceramic soft magnetic material, and a dielectric ceramic material, in which organic resin can be selectively added.

22. A mobile phone capable of reducing an electromagnetic SAR in human bodies, the mobile phone comprising:
a cover, comprising a screen and buttons; and
a base, situated under the cover, the base comprising: a circuit board; and
a meandered planar inverted-F antenna (MPIFA), attached to the back of the circuit board near the bottom of the base, for transmitting and receiving electromagnetic waves, wherein the MPIFA has a number of meandered parts.

23. The mobile phone according to claim 22, wherein the cover is made of an electromagnetic absorbing material in order to mitigate electromagnetic waves radiating from the MPIFA into a user.

24. The mobile phone according to claim 22, wherein the mobile phone comprises an upper cover having one end connected to the upper side of the cover and the upper cover is made of an electromagnetic absorbing material.
